(19) United States
(12) Patent Application Publication
(10) Pub. No.: US 2010/0258991 A1
(43) Pub. Date: Oct. 14, 2010

(54) Jounce Bumper Assembly

(75) Inventors: Mickey L. Love, Londonderry, NH (US); Robert J. Ramm, Amherst, NH (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: FREUDENBERG-NOK GENERAL PARTNERSHIP, Plymouth, MI (US)

(21) Appl. No.: 12/423,370

(22) Filed: Apr. 14, 2009

(51) Int. Cl. F16F 1/36

(52) U.S. Cl. 267/293

(57) ABSTRACT

A jounce bumper assembly is provided and may include a support member for supporting a bumper and adapted to be mounted to a vehicle. The support member may include a base member having a center and a radius, and a projection extending from the base member and away from the bumper. The projection may include a length greater than the radius of the base member and may be formed from a portion of the base member having a longitudinal axis that is skewed from the center of the base member.

### FIELD

The present disclosure relates generally to suspension systems for motor vehicles, and more particularly to an anti-rotation jounce bumper assembly for use in a suspension system of a motor vehicle.

### BACKGROUND

This section provides background information related to the present disclosure which is not necessarily prior art.

Jounce bumper assemblies are often used in motor vehicle suspension systems. Jounce bumper assemblies are typically mounted on a vehicle frame portion, an axle or a suspension system component. The jounce bumper assemblies can be mounted in a free state or with a rigid cup. Jounce bumper assemblies designed to be mounted to a vehicle typically include a rigid cup with a centrally mounted fastener for securing the assembly to the vehicle. During installation, these jounce bumper assemblies can undesirably rotate relative to the vehicle when torque is applied to the fastener. In particular, the jounce bumper assembly may be designed to be positioned in a particular orientation to provide optimal performance characteristics. Accordingly, a need exists for a jounce bumper assembly with an anti-rotation feature that overcomes the aforementioned and other disadvantages.

### SUMMARY

This section provides a general summary of the disclosure, and is not a comprehensive disclosure of its full scope or all of its features.

In one form, a jounce bumper assembly according to the teachings of the present disclosure includes a bumper and a support member for supporting the bumper and adapted to be mounted to a vehicle. The support member may include a base member having a center and a radius, and a projection extending from the base member and away from the bumper. The projection may include a length greater than the radius of the base member and may be formed from a portion of the base member having a longitudinal axis that is skewed from the center of the base member.

In another form, the jounce bumper assembly includes a bumper and a support member for supporting the bumper and adapted to be mounted to a vehicle. The support member may include a base member that may have a center and a radius, and a projection extending from the base member and away from the bumper. The projection may be formed from a portion of the base member having a longitudinal axis that is skewed from the center of the base member. The jounce bumper assembly may further include a spacer that is positioned adjacent the base member and may have an aperture for receiving the projection. The projection extends through the aperture in the spacer and may include a length greater than the radius of the base member so as to have a portion extending beyond the spacer.

In yet another form, a jounce bumper assembly according to the teachings of the present disclosure may include a bumper and a support member for supporting the bumper and adapted to be mounted to a vehicle. The support member may include a base member having a center and a radius, a sidewall extending form the base member, and a projection extending from the base member and away from the bumper. The projection may be formed from a portion of the sidewall.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only and are not intended to limit the scope of the present disclosure.

FIG. 1 is a cross sectional view of a jounce bumper assembly according to the principles of the present disclosure;

FIG. 2 is a side view of a support member of a jounce bumper assembly according to the principles of the present disclosure;

FIG. 3 is a top plan view of a support member according to the principles of the present disclosure;

FIG. 4 is a cross-sectional view taken along line 4-4 of FIG. 3;

FIG. 5 is a top plan view of an alternative jounce bumper support member according to the principles of the present disclosure;

FIG. 6 is a cross sectional view taken along line 6-6 of FIG. 5 and showing a bumper;

FIG. 7 is a top plan view of an alternative support member according to the principles of the present disclosure;

FIG. 8A is a cross-sectional view of an alternative support member according to the principles of the present disclosure;

FIG. 8B is a cross-sectional view of an alternative support member according to the principles of the present disclosure;

FIG. 8C is a cross-sectional view of an alternative support member according to the principles of the present disclosure; and

FIG. 9 is a cross-sectional view of an alternative support member according to the principles of the present disclosure.

Corresponding reference numerals indicate corresponding parts throughout the several views of the drawings.

### DETAILED DESCRIPTION

The following description is merely exemplary in nature and is not intended to limit the present disclosure, application, or uses.

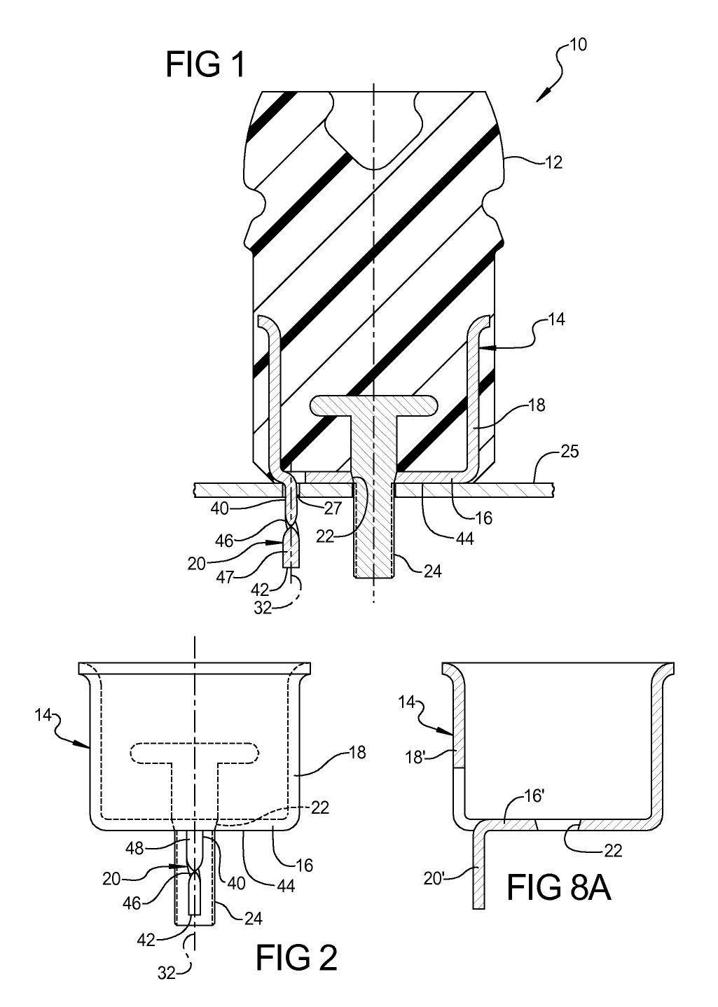

With reference to FIGS. 1-4, a jounce bumper assembly 10 according to the principles of the present disclosure is provided. The jounce bumper assembly 10 includes a bumper 12 and a generally cup-shaped support member 14. The generally cup-shaped support member 14 includes a base member 16 and may include a generally cylindrical sidewall portion 18. Base member 16 includes an anti-rotation projection 20 extending therefrom and may include a centrally located aperture 22 for receiving a fastener 24. The generally cup-shaped support member 14 and fastener 24 are used to mount jounce bumper assembly 10 to a vehicle portion 25 during which the anti-rotation projection 20 engages an aperture 27 of the vehicle portion 25.

The bumper 12 can be supported by the generally cup-shaped support member 14. Bumper 12 may be made from any elastomeric material, including microcellular urethane, rubber, or any other commonly used bumper materials, and may be secured to the generally cup-shaped support member 14 through molding, adhesives, press fit, interference fit or by any other means known in the art. The generally cup-shaped support member 14 may also include retaining tabs formed in the generally cylindrical sidewall 18 and arranged to engage bumper 12. It should be understood that while the generally cup-shaped support member 14 is shown with a cylindrical sidewall portion 18, other geometries such as square, rectangular and oval could also be used for the sidewall portion.

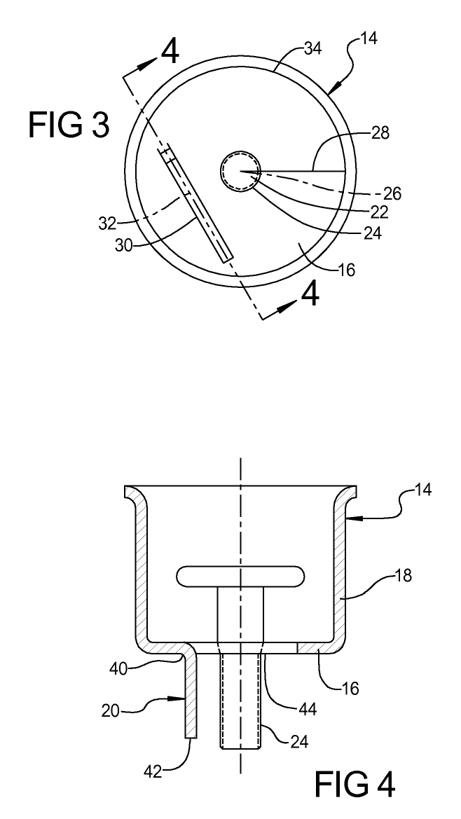

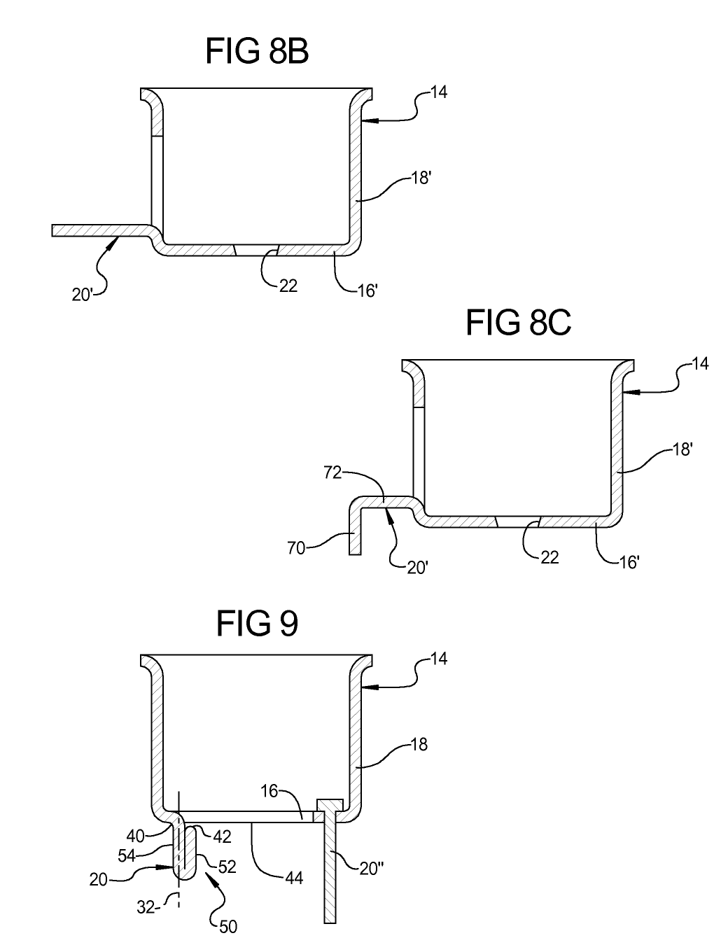

Base member 16 may include a generally circular shape having a center 26 and a radius 28, as illustrated in FIG. 3. The anti-rotation projection 20 can be formed from a portion 30 of the base member 16 as best shown in FIG. 3. The anti-rotation projection portion 30 has a central longitudinal axis 32 that may be skewed from a center of base member 16 and the aperture 22. In this configuration, the anti-rotation projection 20 can be formed from the portion 30 with a length greater than the radius 28 of base member 16, and the length is not limited by an amount of base member material available between the aperture 22 and an outer edge 34 of base member 16. Thus, portion 30 can be positioned in various locations on base member 16 such that anti-rotation projection 20 can be formed with a length that is greater than radius 28 and constrained by a diameter of base member 16 and the aperture 22. It should be noted that the anti-rotation projection 20′ can alternatively be formed from sidewall 18′ or a combination of the base member 16′ and the sidewall 18′ as illustrated in FIG. 8A.

The anti-rotation projection 20 also includes a base member end 40 and an extended end 42 extending from base member 16. The anti-rotation projection 20 may be formed by lancing base member 16 and/or sidewall 18′ and then bending the lanced portion outward such that it extends away from a mounting surface 44 of base member 16 and is substantially orthogonal to base member 16. It should be appreciated that anti-rotation projection 20 can be formed such that it extends from base member 16 at an angle other than ninety degrees as may be required by the environment in which the jounce bumper assembly 10 would be used.

The anti-rotation projection 20 may also include an axial twist 46 about its longitudinal axis 32 to provide added strength and resistance to bending. The axial twist 46 may be formed by twisting or rotating the extended end 42 of anti-rotation projection 20 relative to the base member end 40 about longitudinal axis 32. In one exemplary configuration, the anti-rotation projection 20 has an axial twist of ninety degrees about longitudinal axis 32 between the base member end 40 and extended end 42 as best shown in FIGS. 1 and 2. In this configuration, a plane parallel to a width 47 of extended end 42 would be perpendicular to a plane parallel to a width 48 of base member end 40.

The anti-rotation projection 20 may alternatively include a double back feature 50 for added strength and resistance to bending as shown in FIG. 9. The double back feature may be formed by bending a portion 52 adjacent to extended end 42 back towards base member end 40 such that the portion 52 is parallel to a portion 54 adjacent to base member end 40. In this configuration, both portions 52, 54 may be parallel to the longitudinal axis 32.

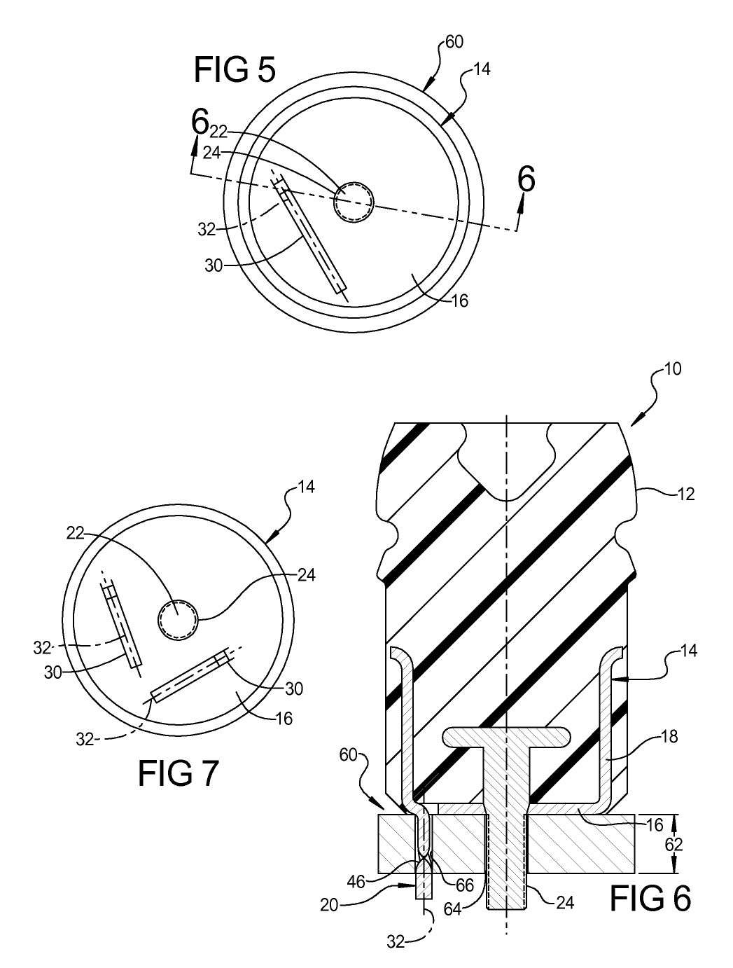

In an alternative configuration and referring to FIGS. 5 and 6, jounce bumper assembly 10 may also include a spacer 60 positioned between the mounting surface 44 of base member 16 and a vehicle component to which the jounce bumper assembly 10 would be mounted. In this exemplary configuration, spacer 60 has a generally cylindrical shape and includes a thickness 62, an aperture 64 for receiving mounting fastener 24, and an aperture 66 for receiving the anti-rotation projection 20.

The anti-rotation projection 20 would be sized in this configuration such that it extends though spacer 60 a sufficient amount that it would then extend into an aperture or other engagement feature in the vehicle arranged to receive the anti-rotation projection 20 upon mounting jounce bumper assembly 10 to the vehicle. By forming the anti-rotation projection 20 from portion 30 that is skewed from aperture 22 or along the sidewall 18′ (as shown in FIG. 8A), the anti-rotation tab can have a length such that the spacer 60 can have varying thicknesses 62 up to and including a thickness 62 greater than radius 28 of generally cup-shaped member 14. The length of anti-rotation projection 20 can also be varied or tailored as needed to accommodate various spacer thicknesses 62 as may be required for different vehicle suspension system configurations.

In another alternative configuration and with additional reference to FIG. 7, jounce bumper assembly 10 may include at least two anti-rotation projections 20 extending from base member 16 and formed from portions 30 or alternatively sidewall 18′. The portions 30 each have longitudinal axes 32 that are skewed from center 26 and aperture 22 of base member 16 such that anti-rotation projections 20 can each have a length greater than radius 28 of base member 16. The anti-rotation projections 20 can extend from base member 16 such that they maintain the same angular relationship to mounting surface 44, or they can extend such that they have different angular relationships relative to mounting surface 44. For example, one of anti-rotation projections 20 could extend such that it is substantially orthogonal to mounting surface 44, while the other one of anti-rotation projections 20 could extend from base member 16 at an angle of forty-five degrees relative to mounting surface 44.

In another alternative configuration and referring to FIG. 8B, anti-rotation projection 20′ may be formed from sidewall 18′ and extend away from sidewall 18′ such that anti-rotation projection 20′ is substantially orthogonal to sidewall 18′. The anti-rotation projection 20′ may further include an angled portion 70 and a non-angled portion 72 adjacent to sidewall 18′. The angled portion 70 may be angled ninety degrees relative to non-angled portion 72 as shown in FIG. 8C. While angled portion 70 is shown with a ninety degree angle relative to non-angled portion 72, it should be appreciated that angled portion 70 may be formed with various angles relative to non-angled portion 72.

In another alternative configuration and with reference to FIG. 9, jounce bumper assembly 10 may also include an alternative anti-rotation projection 20″. Anti-rotation projection 20″ may be fixed to base member 16 in a press-fit configuration through a staking operation so as to protrude through base member 16 as opposed to being formed from the base member and/or sidewall through a lancing operation. Anti-rotation projection 20″ may be further secured to base member 16 through a welding operation. It should be appreciated that while anti-rotation projection 20″ is shown extending from base member 16 at an angle substantially orthogonal to base member 16, anti-rotation projection 20″ could be fixed to base member 16 so as to extend at various angles from base member 16.

In operation, as the jounce bumper assembly 10 is being mounted to a vehicle, the length of anti-rotation projection 20 greater than radius 28 provides for reliably locating and positioning of the jounce bumper assembly 10 prior to securing the assembly to the vehicle via fastener 24. The extended length of anti-rotation projection 20 also provides for additional design flexibility in the vehicle such that the longer projection can be received by a vehicle aperture that may be spaced apart from or at an angle relative to mounting surface 44 of the jounce bumper assembly due to, for example, packaging constraints in the vehicle design.

In securing jounce bumper assembly 10 to the vehicle, a threaded nut or similar mating fastener component would be threaded and tightened onto fastener 24 to seat and secure the jounce bumper assembly 10 to the vehicle. During this operation, the jounce bumper assembly would tend to rotate relative to the vehicle due to the torque imparted on the assembly while securing the nut to fastener 24. The anti-rotation projection 20 prevents such rotation of the jounce bumper assembly 10 during installation and provides for a more reliable and efficient installation process. Further, the extended length anti-rotation projection 20 with the axial twist 46 or double back feature 50 provides for additional strength and resistance to bending, thereby allowing anti-rotation projection 20 to be capable of resisting more rotational torque during the assembly process.

In addition, in a configuration where the jounce bumper assembly 10 includes a spacer 60, the extended length of anti-rotation projection 20 also allows projection 20 to extend through a spacer 60 and into a vehicle aperture to prevent rotation of both the spacer 60 and the jounce bumper assembly 10 during installation to a vehicle as described above. Further, in this configuration, the extended length anti-rotation projection 20 eliminates a need for spacer 60 to have additional anti-rotation features to prevent movement of the spacer 60 relative to the jounce bumper assembly 10 and the vehicle, thereby reducing cost and complexity of the spacer assembly.

The foregoing description of the present disclosure has been provided for purposes of illustration and description. It is not intended to be exhaustive or to limit the invention. Further, the description is merely exemplary in nature and, thus, variations that do not depart from the gist of the disclosure and are intended to be within the scope of the disclosure. Such variations are not intended to depart from the spirit and scope of the disclosure.

What is claimed is:

1. A jounce bumper assembly, comprising:
a bumper;
a support member for supporting the bumper and adapted to be mounted to a vehicle, the support member comprising:
a base member having a center and a radius; and
a projection extending from the base member and away from the bumper, the projection having a length greater than the radius of the base member and being formed from a portion of the base member having a longitudinal axis that is skewed from the center of the base member.

2. The jounce bumper assembly of claim 1, wherein the projection further comprises a base member end and an extended end opposite the base member end, and wherein the projection extended end is twisted about its longitudinal axis relative to the base member end.

3. The jounce bumper assembly of claim 2, wherein the projection extended end is twisted about its longitudinal axis ninety degrees relative to the base member end.

4. The jounce bumper assembly of claim 1, wherein the base member further comprises a mounting aperture having a center aligned with the base member center, and wherein the projection is formed from a portion of the base member having a longitudinal axis that is skewed from the mounting aperture.

5. The jounce bumper assembly of claim 4, wherein the projection extending from the base member comprises at least two projections, each of the at least two projections having a length greater than the radius of the base member and being formed from a portion of the base member having a longitudinal axis that is skewed from the center of the base member.

6. The jounce bumper assembly of claim 1, wherein the projection extending from the base member extends substantially orthogonal to the base member.

7. The jounce bumper assembly of claim 1, wherein the projection is adapted to extend into an aperture in a vehicle portion so as to prevent rotation of the support member relative to the vehicle.

8. The jounce bumper assembly of claim 1, wherein the support member comprises a generally cup-shaped support member.

9. The jounce bumper assembly of claim 1, further comprising a spacer positioned adjacent the base member and having an aperture arranged to receive the projection, and wherein the projection extends through the aperture in the spacer so as to have a portion extending beyond the spacer.

10. The jounce bumper assembly of claim 1, further comprising an additional anti-rotation projection, the additional anti-rotation projection being fixed to the base member in a press-fit configuration and arranged to protrude through the base member so as to extend away from the base member and the bumper.

11. The jounce bumper assembly of claim 1, wherein the anti-rotation projection further comprises a first portion adjacent to the base member and a second portion adjacent to an end of the anti-rotation projection opposite the base member, the first portion extending away from the base member and the second portion being bent towards the base member so as to be parallel to and adjacent the first portion.

12. The jounce bumper assembly of claim 11, wherein the first portion extending away from the base member extends substantially orthogonal to the base member.

13. A jounce bumper assembly, comprising:
a bumper;
a support member for supporting the bumper and adapted to be mounted to a vehicle, the support member comprising:
a base member having a center and a radius;
a projection extending from the base member and away from the bumper, the projection being formed from a portion of the base member having a longitudinal axis that is skewed from the center of the base member; and
a spacer positioned adjacent the base member and having an aperture for receiving the projection;
wherein the projection extends through the aperture in the spacer and has a length greater than the radius of the base member so as to have a portion extending beyond the spacer.

14. The jounce bumper assembly of claim 13, wherein the projection further comprises a base member end and an extended end, and wherein the projection is twisted about its longitudinal axis between the base member end and the extended end.

15. The jounce bumper assembly of claim 14, wherein the projection extended end is twisted about the longitudinal axis ninety degrees relative to the base member end.

16. The jounce bumper assembly of claim 13, wherein the projection extending from the base member extends substantially orthogonal to the base member.

17. The jounce bumper assembly of claim 13, wherein the base member further comprises a mounting aperture having a center aligned with the base member center, and wherein the projection is formed from a portion of the base member having a longitudinal axis that is skewed from the mounting aperture.

18. The jounce bumper assembly of claim 17, wherein the projection extending from the base member comprises at least two projections, each of the at least two projections having a length greater then the radius of the base member and being formed from a portion of the base member having a longitudinal axis that is skewed from the mounting aperture.

19. The jounce bumper assembly of claim 13, wherein the projection portion extending beyond the spacer is adapted to engage a vehicle portion to prevent rotation of the spacer and the support member relative to the vehicle.

20. The jounce bumper assembly of claim 13, wherein the support member comprises a generally cup-shaped support member.

21. A jounce bumper assembly, comprising:
a bumper;
a support member for supporting the bumper and adapted to be mounted to a vehicle, the support member comprising:
a base member having a center and a radius;
a sidewall extending from the base member; and
a projection extending away from the bumper, the projection being formed from a portion of the sidewall.

22. The jounce bumper of claim 21, wherein the projection extends from the base member and away from the bumper.

23. The jounce bumper of claim 22, wherein the base member further comprises a mounting aperture having a center aligned with the base member center, and wherein the projection is formed from a portion of the base member.

24. The jounce bumper assembly of claim 22, wherein the projection extending from the base member extends substantially orthogonal to the base member.

25. The jounce bumper of claim 21, wherein the projection extends from the sidewall and away from the bumper.

26. The jounce bumper of claim 25, wherein the projection extending from the sidewall extends substantially orthogonal to the sidewall.

27. The jounce bumper of claim 26, wherein the projection further comprises a first portion adjacent the sidewall and a second portion adjacent the first portion, the first portion extending from the sidewall substantially orthogonal to the sidewall and the second portion being angled relative to the first portion.

28. The jounce bumper of claim 27, wherein the second portion is angled ninety degrees relative to the first portion.
